(19) United States
(12) Patent Application Publication
(10) Pub. No.: US 2015/0082758 A1
(43) Pub. Date: Mar. 26, 2015

(54) PULSE FILTER DESIGN

(71) Applicant: BHA Altair, LLC, Franklin, TN (US)

(72) Inventors: Rajesh Prabhakaran Saraswathi, Kerala (IN); Stephen David Hiner, Wiltshire (GB); Balakumar Ganesan, Tamil Nadu (IN)

(73) Assignee: BHA Altair, LLC, Franklin, TN (US)

(21) Appl. No.: 14/036,025

(22) Filed: Sep. 25, 2013

(51) Int. Cl. B01D 46/00

(52) U.S. Cl. CPC B01D 46/0021
USPC 55/483

(57) ABSTRACT

A filter element includes a first filter portion extending between a first end and an opposing second end. The first filter portion includes a first cross-sectional dimension that is substantially constant along a length of the first filter portion between the first end and the second end. The filter element includes a second filter portion extending between a third end and an opposing fourth end with the third end being located adjacent the second end. The third end has a third end cross-sectional dimension that substantially matches the first cross-sectional dimension. The fourth end has a fourth end cross-sectional dimension that is smaller than the third end cross-sectional dimension.

### BACKGROUND OF THE INVENTION

1. Field of the Invention

The invention relates generally to a filter element and, more particularly, to a filter element having an improved filtration efficiency.

2. Discussion of the Prior Art

Inlet systems for gas turbines are generally used for treating air that passes to the gas turbine. The air can be treated by filtering the air with one or more filter elements provided within the inlet system. The filtration efficiency of the inlet system is somewhat constrained by the total number of filter elements that can be accommodated within the inlet system. Additionally, factors such as the total area of filtration media, pressure drop caused by the filter elements, etc. can also affect the filtration efficiency of the inlet system. Accordingly, it would be useful to provide a filter element having a size and/or construction that allows for a greater total number of filter elements to be provided in the inlet system so as to provide an improved filtration efficiency.

### BRIEF DESCRIPTION OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect, the present invention provides a filter element including a first filter portion extending between a first end and an opposing second end. The first filter portion includes a first cross-sectional dimension that is substantially constant along a length of the first filter portion between the first end and the second end. The filter element includes a second filter portion extending between a third end and an opposing fourth end with the third end being located adjacent the second end. The third end has a third end cross-sectional dimension that substantially matches the first cross-sectional dimension, the fourth end having a fourth end cross-sectional dimension that is smaller than the third end cross-sectional dimension.

In accordance with another aspect, the present invention provides a filter element including a first filter portion extending along a longitudinal axis between a first end and an opposing second end. The filter element includes a second filter portion extending along the longitudinal axis between a third end and an opposing fourth end. The first filter portion and second filter portion include a plurality of sides that are substantially planar.

In accordance with another aspect, the present invention provides a filter element including a first filter portion extending along a longitudinal axis between a first end and an opposing second end. The first filter portion includes a substantially cylindrical shape. The filter element includes a second filter portion extending along the longitudinal axis between a third end and an opposing fourth end with the third end being located adjacent the second end. The second filter portion includes a substantially conical shape. The first filter portion and second filter portion include a plurality of sides that are substantially planar.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a schematized cross-section view of an example inlet system including an example filter element in accordance with an aspect of the present invention

FIG. 2 is a perspective view of the example filter element including an example partition in accordance with an aspect of the present invention;

FIG. 3 is a side elevation view of the example filter element of FIG. 2, including example dimensions of the filter element;

FIG. 4 is a schematized perspective view of a second example filter element in accordance with an aspect of the present invention;

FIG. 5 is a side elevation view of the second example filter element of FIG. 4, including example dimensions of the second filter element;

FIG. 6 is a schematized perspective view of a third example filter element in accordance with an aspect of the present invention;

FIG. 7 is a side elevation view of the third example filter element of FIG. 6, including example dimensions of the third filter element;

FIG. 8 is an end view of a fourth example filter element in accordance with an aspect of the present invention;

FIG. 9 is a cross-section view of an example of one of the second filter element, third filter element, or fourth filter element.

### DETAILED DESCRIPTION OF THE INVENTION

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

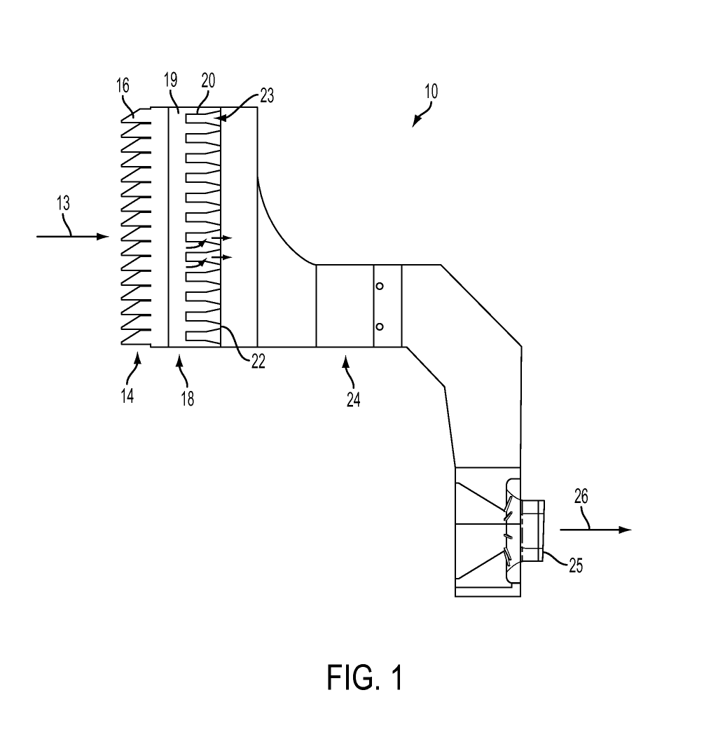

FIG. 1 illustrates an example inlet system 10 for delivering an air flow to a device, such as a gas turbine, according to one example. An entering air flow 13 can be drawn from an exterior location and into the inlet system 10. The entering air flow 13 can be filtered before exiting the inlet system 10.

The inlet system 10 can include an inlet section 14. It should be appreciated that the inlet section 14 is somewhat generically shown within FIG. 1. This generic representation is intended to convey the concept that the inlet section 14 of the inlet system 10 shown in FIG. 1 can represent a prior art construction or a construction in accordance with one or more aspects of the present invention as will be described below. The inlet section 14 can be positioned at an upstream location of the inlet system 10. The inlet section 14 can define an open area through which the entering air flow 13 can enter the inlet system 10. The inlet section 14 can include one or more hoods 16. The hoods 16 can provide a shielding function to help protect the inlet system 10 from ingesting at least some materials and/or precipitation that may otherwise enter the inlet section 14.

The example inlet system 10 can further include a filter section 18 positioned adjacent to, and downstream from, the inlet section 14. The filter section 18 can be in fluid communication with the inlet section 14, such that the filter section 18 can receive the entering air flow 13 from the inlet section 14. The filter section 18 defines a chamber 19 that includes a substantially open area. The chamber 19 can be substantially hollow such that air can enter and flow through the chamber 19.

The filter section 18 can further include one or more filter elements 20 positioned within the chamber 19. The filter elements 20 are shown to extend substantially horizontally within the filter section 18 and can be arranged in a vertically stacked orientation (i.e., one filter element above another filter element). However, in other examples, the filter elements 20 can be arranged in a vertically staggered position, such that a filter element 20 is not positioned directly above or below an adjacent filter element. The filter elements 20 can be positioned adjacent a bottom wall of the filter section 18 at a lower location. The filter elements 20 can be substantially evenly spaced apart from adjacent filter elements in the vertically stacked orientation upwards towards a top wall. In further examples, the filter elements 20 may not be evenly spaced apart in the vertical direction, such that some filter elements are closer or farther apart from adjacent filter elements than others. Similarly, the filter elements 20 can be arranged to be horizontally spaced apart, such that the filter elements 20 can extend across the filter section 18 in a column-like formation. It is to be understood that the filter elements 20 are only generically shown, and that the inlet system 10 could include a greater or fewer number of filter elements than in the shown example.

The filter elements 20 can each be attached to a partition 22 that is positioned at a downstream location of the filter section 18. The partition 22 can include a substantially vertically oriented wall that extends across the filter section 18 in a direction substantially perpendicular to an air flow direction. Specifically, the partition 22 can extend from the bottom wall towards the top wall and between opposing side walls of the filter section 18. The partition 22 can include a substantially non-porous structure, such that air flow is reduced and/or prevented from flowing through the partition 22.

The partition 22 includes one or more apertures 23 extending through the partition 22. The apertures 23 define openings through which the air flow can exit the filter section 18. As such, each of the filter elements 20 can be attached to surround an aperture 23. The entering air flow 13 can therefore pass through the filter elements 20 prior to passing through the apertures 23 and exiting the filter section 18. After exiting the filter section 18, the air can pass through the outlet section 24 and through an outlet 25, whereupon the air exits the outlet 25 as exiting air flow 26.

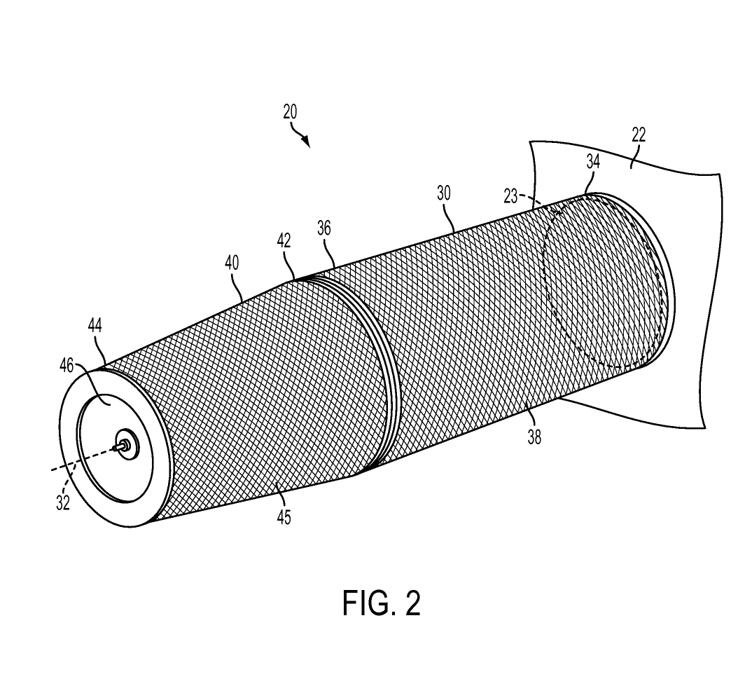

Turning now to FIG. 2, an example filter element 20 is illustrated. As shown in FIG. 2, a single filter element 20 is depicted attached to a section of the partition 22. It is to be understood that the filter element 20 and partition 22 are somewhat generically shown within FIG. 2, and could take on a variety of constructions in accordance with one or more aspects of the present invention. For instance, the remaining filter elements can be similar and/or identical to the filter element 20 in the shown example or, in the alternative, could take on a number of different sizes and shapes. In some examples, the filter element 20 can include a plurality of filters (e.g., greater than two) joined together to form the single filter element 20. In one possible example, the filter element 20 comprises a single, one-piece filter element.

The filter element 20 can include a first filter portion 30. The first filter portion 30 can extend along a longitudinal axis 32 between a first end 34 and an opposing second end 36. In an example, the first end 34 of the first filter portion 30 is attached to the partition 22. The first end 34 can be attached to the partition 22 in any number of ways, including, but not limited to, adhesives, mechanical fasteners, snap fit means, or the like. The first end 34 of the first filter portion 30 can include a cross-sectional size (e.g., diameter, etc.) that substantially matches or is slightly larger than a diameter of an aperture 23 (shown only in phantom in FIG. 2, as the aperture 23 is normally not visible in such a view) through the partition 22. The first filter portion 30 can include a first filter media 38. The first filter media 38 can be arranged to circumferentially encircle and extend along the longitudinal axis 32. The first filter media 38 includes any number of materials that can filter particulates from air.

The first filter portion 30 can have a substantially cylindrical shape, and, in particular, a circle-cylinder shape. In an example, the first filter portion 30 includes a circular cross-section with a substantially constant cross-sectional dimension (e.g., diameter) along the longitudinal axis 32 between the first end 34 and the second end 36. The first filter portion 30 may include any selected dimensions (e.g., diameter and axial length). In an example, the first filter portion 30 includes a length of about 66 cm (˜26 inches).

The filter element 20 can include a second filter portion 40. The second filter portion 40 can extend along the longitudinal axis 32 between a third end 42 and an opposing fourth end 44. In an example, the third end 42 of the second filter portion 40 is positioned adjacent the second end 36 of the first filter portion 30. In some examples, the third end 42 of the second filter portion 40 is attached to the second end 36 of the first filter portion 30. The third end 42 can be positioned substantially flush with respect to the second end 36, such that the first filter portion 30 and second filter portion 40 define a substantially contiguous filter element with limited/reduced openings, gaps, etc. through which air can pass through. The second filter portion 40 can include a truncated conical shape as one example conical shape. Also, as an example, the conical shape has a circular cross-section that varies in size along the axis (i.e., the diameter varies). In an example, the truncated conical shape of the second filter portion 40 can be tapered in a direction along the longitudinal axis 32 away from the first filter portion 30. As such, the diameter decreases as the second filter portion 40 extends away from the first filter portion 30. The second filter portion 40 can include a second filter media 45. The second filter media 45 can be arranged to circumferentially encircle and extend along the longitudinal axis 32. The second filter media 45 includes any number of materials that can filter particulates from air.

The filter element 20 can further include an end cap 46. The end cap 46 can function to seal the fourth end 44 of the second filter portion 40. The end cap 46 can be positioned at the fourth end 44 of the second filter portion 40 located opposite the first filter portion 30. The end cap 46 is shown to be circular in shape, though a variety of sizes/shapes are contemplated. Accordingly, the end cap 46 can reduce and/or prevent the passage of air through the end of the filter element 20.

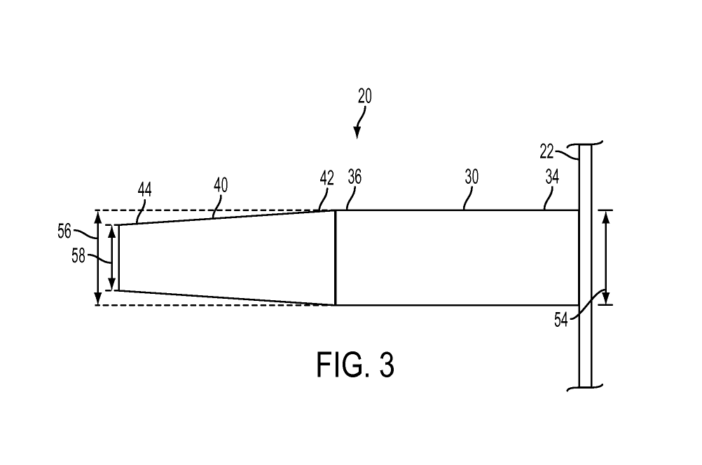

Turning to FIG. 3, a side elevation view of the filter element 20 is illustrated. In this example, the first filter portion 30 can include a first cross-sectional dimension 54. In an example, the first cross-sectional dimension 54 includes a diameter. In other examples, the first filter portion 30 is not limited to including a circular, cylindrical shape with a circular cross-section, and other shapes are envisioned. In an example, the first cross-sectional dimension 54 (e.g., diameter) of the first filter portion 30 is about 42 cm (˜16.5 inches). It will be appreciated, however, that the first filter portion 30 is not limited to this size, and, in other examples, could be larger or smaller than as illustrated.

The second filter portion 40 can include a third end cross-sectional dimension 56. In an example, the third end cross-sectional dimension 56 includes a dimension (e.g., diameter) of the third end 42 of the second filter portion 40. The second filter portion 40 is not limited to including a truncated, conical shape with a circular cross-section, as other shapes are envisioned. In an example, the third end cross-sectional dimension 56 (e.g., diameter) of the second filter portion 40 is about 42 cm (˜16.5 inches). It will be appreciated, however, that the second filter portion 40 is not limited to this size, and, in other examples, could be larger or smaller than as illustrated. In some examples, the third end cross-sectional dimension 56 substantially matches the first cross-sectional dimension 54.

The second filter portion 40 can include a fourth end cross-sectional dimension 58. In an example, the fourth end cross-sectional dimension 58 includes a dimension (e.g., diameter) of the fourth end 44 of the second filter portion 40. In an example, the fourth end cross-sectional dimension 58 of the second filter portion 40 is about 32 cm (˜12.75 inches). It will be appreciated, however, that the fourth end cross-sectional dimension 58 is not limited to this size, and, in other examples, could be larger or smaller than as illustrated. In an example, the fourth end cross-sectional dimension 58 is smaller than the third end cross-sectional dimension 56 and the first cross-sectional dimension 54.

The filter element 20 provides a number of benefits. In an example, the filter element 20 has a maximum cross-sectional size (e.g., diameter) of about 42 cm (˜16.5 inches) at the first cross-sectional dimension 54 and the third end cross-sectional dimension 56. These cross-sectional sizes are smaller than in previous examples, such that a greater number of filter elements 20 can be housed within the chamber 19 of the filter section 18, thus leading to an improved filtration efficiency of the inlet system 10. In an example, the filter element 20 provides a larger total area of filter media (e.g., first filter media 38 and second filter media 45) such that filtration capability of the filter element 20 is improved. In an example, with first filter portion 30 and second filter portion 40 each comprising a length of about 66 cm (˜26 inches), the filter element 20 includes a total filtration area of about 52 m². In such an example, the first filter portion 30 has a total filtration area of about 34.5 m² while the second filter portion 40 has a total filtration area of about 17 m². By having a maximized diameter at the junction where the first filter portion 30 joins the second filter portion 40, pressure loss is reduced across this junction, leading to a reduced pressure drop. In addition, flow distribution and filter media utilization is increased, leading to improved filtration efficiency, longer filter life, more effective pulse cleaning, etc.

In some examples, due to these improvements in the filter element 20, a fewer total number of filter elements 20 may be provided in the filter section 18 while still achieving a similar or greater filtration efficiency of the inlet system 10, thus leading to a smaller sized (e.g., reduced height) filter section 18. In one possible example, the filter section 18 may have a reduced height of about 91 cm (˜3 ft). Further, the filter elements 20 can exhibit a lower pressure drop within the filter section 18, which leads to a longer filter life, better filtration, efficiency, etc. In some examples, the filter elements 20 reduces pressure drop within the filter section 18 by 0.2 inches water gauge.

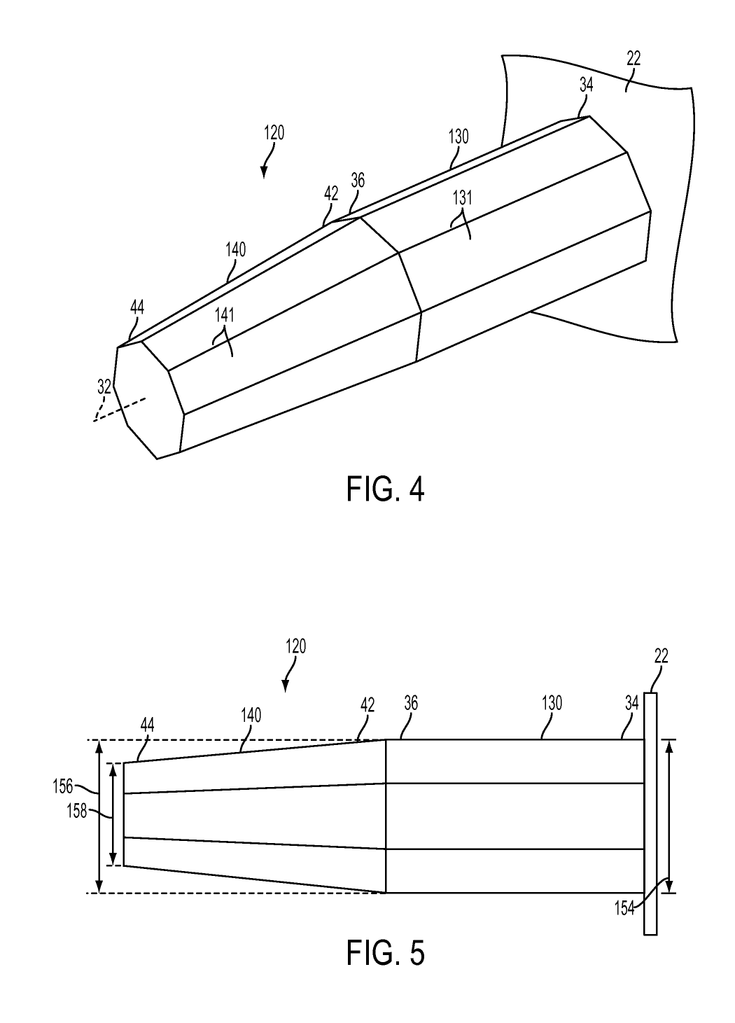

Turning to FIG. 4, a second example filter element 120 is illustrated. It will be appreciated that the second filter element 120 is illustrated somewhat generically/schematically so as to illustrate the structure of the second filter element 120. In general, the second filter element 120 can be attached to the partition 22 at an aperture (not shown) in a similar manner as described with respect to the filter element 20. The second filter element 120 can include a filter media, such as, for example, the first filter media 38 and second filter media 45, for filtering particulates from air.

The second filter element 120 can include a first filter portion 130. The first filter portion 130 can extend along the longitudinal axis 32 between the first end 34 and the opposing second end 36. The first filter portion 130 of the second filter element 120 can be attached to the partition 22. In some examples, the first filter media 38 comprises a plurality of different first filter media 38 for different first sides 131 of the first filter portion 130. For example, one of the first sides 131 can include a first type of the first filter media 38 while another of the first sides 131 can include a second type of the first filter media 38, wherein the second type of the first filter media 38 is different than the first type of the first filter media 38. Differences in the first filter media 38 for differing first sides 131 include, but are not limited to, the type of filter media, thickness, filtration efficiency, media area, pleating, etc.

The first filter portion 130 can include a generally cylindrical shape with a polygonal cross-section. For example, the first filter portion 130 includes a generally constant cross-sectional dimension extending along the longitudinal axis 32. In this example, the first filter portion 130 includes one or more first sides 131 that are substantially planar. In the illustrated example, the first filter portion 130 can include eight first sides 131, such that the first filter portion 130 defines an octagonal cross-section. As such, the presented example is an eight-sided or octagon cylinder. The first filter portion 130 is not limited to including eight first sides 131, and in other examples, could include any number of sides, including planar sides. In an example, the first filter portion 130 includes a length of about 66 cm (˜26 inches).

The second filter element 120 can include a second filter portion 140. The second filter portion 140 can extend along the longitudinal axis 32 between the third end 42 and the opposing fourth end 44. In an example, the third end 42 of the second filter portion 140 is positioned adjacent the second end 36 of the first filter portion 130. The third end 42 can be positioned substantially flush with respect to the second end 36, such that the first filter portion 130 and second filter portion 140 define a substantially contiguous filter element with limited/reduced openings, gaps, etc. through which air can pass through.

The second filter portion 140 can include a truncated conical shape with a polygonal cross-section. For example, the second filter portion 140 can be tapered in a direction along the longitudinal axis 32 away from the first filter portion 130. In some examples, the second filter portion 140 has a generally decreasing cross-sectional dimension extending along the longitudinal axis 32 from the third end 42 to the fourth end 44. In some examples, the second filter portion 140 includes one or more second sides 141 that are substantially planar. In the illustrated example, the second filter portion 140 can include eight second sides 141, such that the second filter portion 140 defines an octagonal cross-section. The second filter portion 140 is not limited to including eight second sides 141, and in other examples, could include any number of sides, including planar sides. In an example, the second filter portion 140 includes a length of about 66 cm (˜26 inches).

In some examples, the second filter media 45 comprises a plurality of different second filter media 45 for different second sides 141 of the second filter portion 140. For example, one of the second sides 141 can include a first type of the second filter media 45 while another of the second sides 141 can include a second type of the second filter media 45, wherein the second type of the second filter media 45 is different than the first type of the second filter media 45. Differences in the second filter media 45 for differing second sides 141 include, but are not limited to, the type of filter media, thickness, filtration efficiency, media area, pleating, etc.

Turning to FIG. 5, a side elevation view of the second filter element 120 is illustrated. In this example, the first filter portion 130 includes a first cross-sectional dimension 154. In an example, the first cross-sectional dimension 154 of the first filter portion 130 is about 42 cm (˜16.5 inches). It will be appreciated, however, that the first filter portion 130 is not limited to this size, and, in other examples, could be larger or smaller than as illustrated.

The second filter portion 140 can include a third end cross-sectional dimension 156. The third end cross-sectional dimension 156 includes a dimension of the third end 42 of the second filter portion 140. In an example, the third end cross-sectional dimension 156 of the second filter portion 140 is about 42 cm (˜16.5 inches). It will be appreciated, however, that the second filter portion 140 is not limited to this size, and, in other examples, could be larger or smaller than as illustrated. In some examples, the third end cross-sectional dimension 156 substantially matches the first cross-sectional dimension 154.

The second filter portion 140 can include a fourth end cross-sectional dimension 158. The fourth end cross-sectional dimension 158 includes a dimension of the fourth end 44 of the second filter portion 140. In an example, the fourth end cross-sectional dimension 158 of the second filter portion 140 is about 32 cm (˜12.75 inches). It will be appreciated, however, that the fourth end cross-sectional dimension 158 is not limited to this size, and, in other examples, could be larger or smaller than as illustrated. In an example, the fourth end cross-sectional dimension 158 is smaller than the third end cross-sectional dimension 156 and the first cross-sectional dimension 154.

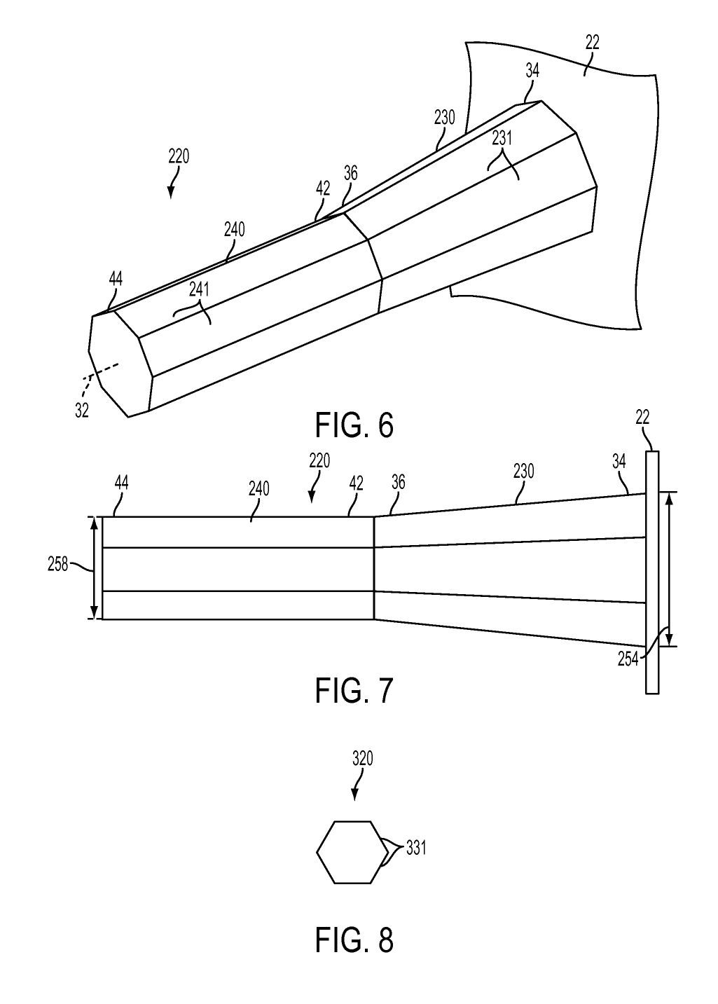

Turning to FIG. 6, a third example filter element 220 is illustrated. It will be appreciated that the third filter element 220 is illustrated somewhat generically/schematically so as to illustrate the structure of the third filter element 220. In general, the third filter element 220 can be attached to the partition 22 in a similar manner as described with respect to the filter element 20 and the second filter element 120. The third filter element 220 can include a filter media, such as, for example, the first filter media 38 and second filter media 45, for filtering particulates from air.

The third filter element 220 can include a first filter portion 230. The first filter portion 230 can extend along the longitudinal axis 32 between the first end 34 and the opposing second end 36. The first filter portion 230 of the third filter element 220 can be attached to the partition 22.

The first filter portion 230 can include a truncated conical shape with a polygonal cross-section. For example, the first filter portion 230 can be tapered in a direction along the longitudinal axis 32 away from the partition 22. In some examples, the first filter portion 230 has a generally decreasing cross-sectional dimension extending along the longitudinal axis 32 from the first end to the second end 36. In some examples, the first filter portion 230 includes one or more first sides 231 that are planar. In the illustrated example, the first filter portion 230 can include eight first sides 231, such that the first filter portion 230 defines an octagonal cross-section. The first filter portion 230 is not limited to including eight first sides 231, and in other examples, could include any number of sides, including planar sides. In an example, the first filter portion 230 includes a length of about 66 cm (˜26 inches).

The third filter element 220 can include a second filter portion 240. The second filter portion 240 can extend along the longitudinal axis 32 between the third end 42 and the opposing fourth end 44. In an example, the third end 42 of the second filter portion 140 is positioned adjacent and in attachment with the second end 36 of the first filter portion 230. The third end 42 can be positioned substantially flush with respect to the second end 36, such that the first filter portion 230 and second filter portion 240 define a substantially contiguous filter element with limited/reduced openings, gaps, etc. through which air can pass through.

The second filter portion 240 can include a substantially cylindrical shape with a polygonal cross-section. For example, the second filter portion 240 includes a generally constant cross-sectional dimension extending along the longitudinal axis 32. In this example, the second filter portion 240 includes one or more second sides 241 that are planar. In the illustrated example, the second filter portion 240 can include eight second sides 241, such that the second filter portion 240 defines an octagonal cross-section. The second filter portion 240 is not limited to including eight second sides 241, and in other examples, could include any number of sides, including planar sides. In an example, the second filter portion 240 includes a length of about 66 cm (˜26 inches).

Turning to FIG. 7, a side elevation view of the third filter element 220 is illustrated. In this example, the first filter portion 230 includes a first cross-sectional dimension 254. In this example, the first cross-sectional dimension 254 represents a cross-sectional dimension at the first end 34 of the first filter portion 230. In an example, the first cross-sectional dimension 254 at the first end 34 of the first filter portion 230 is about 42 cm (˜16.5 inches). It will be appreciated, however, that the first filter portion 230 is not limited to this size, and, in other examples, could be larger or smaller than as illustrated. In an example, a cross-sectional dimension at the second end 36 of the first filter portion 34 is about 32 cm (˜12.75 inches).

The second filter portion 240 can include a second cross-sectional dimension 258. The second cross-sectional dimension 258 includes a dimension of the second filter portion 240 at nearly any location along a length of the second filter portion 240 (e.g., at the third end 42, at the fourth end 44, etc.). In an example, the second cross-sectional dimension 258 of the second filter portion 240 is about 32 cm (˜12.75 inches). In the illustrated example, the second cross-sectional dimension 258 substantially matches a cross-sectional dimension of the second end 36 of the first filter portion 230. It will be appreciated, however, that the second filter portion 240 is not limited to this size, and, in other examples, could be larger or smaller than as illustrated. The second cross-sectional dimension 258 can be less than the first cross-sectional dimension 254.

Turning now to FIG. 8, an end view of a fourth example filter element 320 is illustrated. It will be appreciated that the fourth filter element is illustrated somewhat generically/schematically for illustrative purposes. In an example, the fourth filter element 320 can include at least some structures similar to the filter elements 20, 120, 220. For example, the fourth filter element 320 can be attached to the partition 22 and can include a filter media (e.g., first filter media 38 and second filter media 45). In the illustrated example, the fourth filter element 320 can include a hexagonal cross-sectional shape. The fourth filter element 320 can include six sides 331 that are planar. In an example, similar to the second filter element 120 of FIG. 4, the fourth filter element 320 can include a first filter portion that is substantially cylindrical and a second filter portion that is substantially conical. In another example, similar to the third filter element 220 of FIG. 6, the fourth filter element 320 can include a first filter portion that is substantially conical and a second filter portion that is substantially cylindrical.

As illustrated in FIGS. 4 to 8, the filter elements 120, 220, 320 having one or more substantially planar sides provide a number of benefits. In one example, the filter elements 120, 220, 320 can include a staggered arrangement within the chamber 19 of the filter section 18. For example, the substantially planar sides (e.g., first sides 131, 231, 331 and/or second sides 141, 241, 331) of one filter element 120, 220, 320 can be positioned adjacent and in proximity to substantially planar sides (e.g., first sides 131, 231, 331 and/or second sides 141, 241, 331) of an adjacent filter element 120, 220, 320. In some examples, adjacent substantially planar sides of adjacent filter elements can extend generally parallel with respect to each other, with a small opening, gap, space, etc. therebetween. This staggered arrangement of the filter elements 120, 220, 320 can allow for a larger number of the filter elements 120, 220, 320 to be housed within the filter section 18, thus leading to an increased filtration capacity of the inlet system 10.

As illustrated in FIGS. 2 to 8, the filter elements 20, 120, 220, 320 each include the filter media 38, 45 comprising a plurality of different media configurations. For example, in some examples, the filter media 38, 45 is arranged to have the substantially cylindrical shape (e.g., as illustrated in FIG. 2). In other examples, the filter media 38, 45 is arranged to include one or more planar sides (e.g., sides 131, 141, 231, 241, 331, etc.). In these examples, the filter elements 20, 120, 220, 320 provide a number of benefits, including, but not limited to, better flow distribution and filter media utilization, improved filtration efficiency, longer filter life, more effective pulse cleaning, etc.

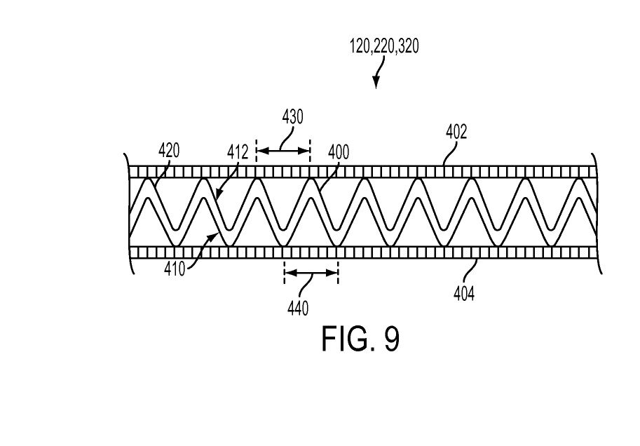

Turning now to FIG. 9, a sectional view of a portion of one of the second filter element 120, third filter element 220, or fourth filter element 320 is illustrated. In particular, a side of one of the second filter element 120, third filter element 220, or fourth filter element 320 is illustrated. It will be appreciated that the illustrated side is generally planar, and can include portions of any one of the illustrated sides 131, 141, 231, 241, 331.

The filter elements, 120, 220, 320 can include a filter media 400. The filter media 400 includes any number of different materials. For example, the filter media 400 can include a variety of filtering materials that function to remove particulates from air that passes through the filter media 400. In an example, the filter media 400 can include polytetrafluoroethylene (PTFE) or expanded polytetrafluoroethylene (ePTFE), for example.

In some examples, the filter media 400 can be supported by a first support device 402. In an example, the first support device 402 can extend concentrically about the filter media 400. The first support device 402 can have a larger diameter than the filter media 400. The first support device 402 can define an outermost surface of the filter elements 120, 220, 320. In an example, the first support device 402 can form a generally linear side so as to match the polygonal shape of the filter elements 120, 220, 320. It will be appreciated that the first support device 402 may not be present in all examples of the filter elements 120, 220, 320. Rather, in some examples, the filter elements 120, 220, 320 may not be provided with the first support device 402.

The filter media 400 can be supported by a second support device 404. The second support device 404 defines an innermost surface of the filter elements 120, 220, 320. The second support device 404 can be spaced apart inwardly from the first support device 402 to define an opening, chamber, etc. extending between the first support device 402 and the second support device 404. In an example, the second support device 404 can extend generally linearly to extend generally parallel to the first support device 402.

It will be appreciated that the second support device 404 may not be present in all examples of the filter elements 120, 220, 320. Rather, in some examples, the filter elements 120, 220, 320 may not be provided with the second support device 404. In some possible examples, either or both of the first support device 402 or second support device 404 may be replaced by a scrim, adhesive, adhesive impregnated string, other support device, etc., alone or in combination. Likewise, in some examples, the filter elements 120, 220, 320 may not include both of the first support device 402 and second support device 404. Rather, the filter elements 120, 220, 320 may instead include one of the first support device 402 or the second support device 404.

The filter media 400 defines an inner surface 410 and an outer surface 412. The inner surface 410 can at least partially be in contact with and/or supported by the second support device 404. The outer surface 412 can at least partially be in contact with and/or supported by the first support device 402. In some examples, the filter media 400 is arranged so as to include a plurality of pleats 420 that extend in a substantially zig-zag pattern toward and away from the first support device 402 and the second support device 404.

By providing the filter elements 120, 220, 320 with one or more substantially planar sides 131, 141, 231, 241, 331, spacing between the pleats is maintained substantially constant. For example, an outer separating distance 430 is a distance separating adjacent outer pleats 420 supported by the first support device 402. An inner separating distance 440 is a distance separating adjacent inner pleats 420 supported by the second support device 404. In an example, the outer separating distance 430 can substantially match the inner separating distance 440 due, at least in part, to the pleats 420 forming substantially planar sides 131, 141, 231, 241, 331. As such, bunching of the pleats 420 at an inner location, as is known to occur in rounded/curved filter elements, is reduced. In addition to bunching (e.g., an irregular grouping of pleats), tightness of pleat exit compared to pleat entry is also reduced. As a result, in some examples, pressure loss is reduced while filtration efficiency and filter life are increased through better media utilization and improved pulse cleaning.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A filter element including:
a first filter portion extending between a first end and an opposing second end, the first filter portion including a first cross-sectional dimension that is substantially constant along a length of the first filter portion between the first end and the second end; and
a second filter portion extending between a third end and an opposing fourth end with the third end being located adjacent the second end, the third end having a third end cross-sectional dimension that substantially matches the first cross-sectional dimension, the fourth end having a fourth end cross-sectional dimension that is smaller than the third end cross-sectional dimension.

2. The filter element of claim 1, wherein the first filter portion includes a substantially cylindrical shape.

3. The filter element of claim 1, wherein the second filter portion includes a substantially truncated conical shape.

4. The filter element of claim 1, wherein the first filter portion includes one or more first sides that are substantially planar.

5. The filter element of claim 4, wherein the first filter portion includes eight first sides that are substantially planar to define an octagonal cross-section.

6. The filter element of claim 1, wherein the second filter portion includes one or more second sides that are substantially planar.

7. The filter element of claim 6, wherein the second filter portion includes eight second sides that are substantially planar to define an octagonal cross-section.

8. The filter element of claim 7, wherein the second filter portion includes a substantially conical shape.

9. The filter element of claim 1, wherein the filter element comprises a plurality of filter portions.

10. The filter element of claim 1, wherein the filter media comprises a plurality of media configurations.

11. The filter element of claim 1, wherein the first filter portion and second filter portion include a filter media arranged into a plurality of pleats.

12. The filter element of claim 11, wherein an outer separating distance separating adjacent outer pleats substantially matches an inner separating distance that separates adjacent inner pleats.

13. A filter element including:
a first filter portion extending along a longitudinal axis between a first end and an opposing second end; and
a second filter portion extending along the longitudinal axis between a third end and an opposing fourth end, the first filter portion and second filter portion including a plurality of sides that are substantially planar.

14. The filter element of claim 13, wherein the first filter portion includes eight first sides that are substantially planar to define an octagonal cross-section.

15. The filter element of claim 14, wherein the first filter portion includes a substantially cylindrical shape.

16. The filter element of claim 13, wherein the second filter portion includes eight second sides that are substantially planar to define an octagonal cross-section.

17. The filter element of claim 16, wherein the second filter portion includes a substantially conical shape.

18. The filter element of claim 13, wherein the filter media comprises a plurality of media configurations.

19. A filter element including:
a first filter portion extending along a longitudinal axis between a first end and an opposing second end, the first filter portion including a substantially cylindrical shape; and
a second filter portion extending along the longitudinal axis between a third end and an opposing fourth end with the third end being located adjacent the second end, the second filter portion including a substantially conical shape, wherein the first filter portion and second filter portion including a plurality of sides that are substantially planar.

20. The filter element of claim 19, wherein the third end of the second filter portion has a third end cross-sectional dimension that substantially matches a first cross-sectional dimension of the first filter portion.
